(19) United States
(12) Patent Application Publication
(10) Pub. No.: US 2003/0121991 A1
(43) Pub. Date: Jul. 3, 2003

(54) Nozzle with cover for spraying printed circuit board

(75) Inventor: Chol-Won Park, Jinhae-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/118,235

(22) Filed: Apr. 9, 2002

(30) Foreign Application Priority Data
Dec. 28, 2001 (KR) 2001-87138

(51) Int. Cl. B05B 1/28

(52) U.S. Cl. 239/288

(57) ABSTRACT

A nozzle used in spraying process for PCBs is disclosed. The nozzle includes a funnel-shaped cover attached to an upper portion of the nozzle to hide the nozzle. With the cover, it is possible to prevent interference between liquid fallen from a nozzle bar and liquid sprayed from the nozzle, and it is thus to maintain uniform spray pressure during spraying process for PCBs, thereby maintaining chemical reaction such as development and etching and washing capability uniformly to improve quality of PCBs.

### BACKGROUND OF THE INVENTION

1. Field of the Invention

The present invention relates to a spray nozzle used in a spraying process for printed circuit board (hereinafter, referred to “PCB”), and more particularly to an improved nozzle for spraying processing liquid on PCBs which are horizontally transferred in a wet line equipment.

2. Description of the Prior Art

In general, a spray nozzle is extensively used in various chemical treatments and washing processes such as pretreating, developing, peeling, etching and washing, which are required in a process for producing PCBs.

Recently, PCBs are required to achieve rapid improvement in circuit density and reduction of clearances, as various miniaturized, lightened and highly dense electronic items are developed. TO cope with this situation, PCBs are evolving toward BGA, CSP, FLIP-CHIP types of PCBs. Furthermore, to improve circuit's density, a line width of a PCB is recently reduced to 75 μm from 100 μm or more in the past, and it is expected that the line width is reduced to 40 μm until about 2004 years. Intervals between line widths are also rapidly reduced.

In connection with the improvement in circuit density, an impedance value of a finished PCB is becoming an important factor to deal with improvement of high frequency characteristics and processing speed and development of image processing technique. Though a tolerance zone of circuit line width was about ±20% in conventional usual PCBs because there is not required to separately assign or control impedance, a tolerance zone of circuit line width of products, which are required to control impedance, is ±10 in these days. Moreover, the tolerance zone will be required to be ±5% in the future. As such, progress of PCBs is very remarkable in terms of high accuracy and density.

PCBs are generally produced by carrying out a plurality of processes such as drilling, plating, formation of circuits and lamination in sequence. The processes may include a pretreating process for removing foreign substance from PCBs and washing PCBs, an etching process, a process for peeling an etching resist, a PSR development process and various washing and water washing processes, if required.

These processes are carried out by reaction to various chemical liquids while PCBs are charged into a wet line equipment and then horizontally transferred in the equipment by a drive unit. The equipments are provided with nozzles for spraying liquid on PCBs, respectively.

Wet line equipments are disclosed in U.S. Pat. Nos. 5,534,067 and 5,228,949 and Japanese Patent Laid-open Publication No. 2000-237649. The wet line equipements disclosed in the US patents and the Japanese publication are configured to carry out processes such as development and etching by spraying PCBs with various chemical solution from a plurality of nozzles disposed above and under the PCBs while the PCBs are horizontally transferred by a conveyer placed in the equipment. Additionally, Japanese Patent Laid-open Publication No. 2000-237649 discloses a spraying equipment including a tank containing treating solution, a pump for pumping from the tank, piping through which the pumped solution is fed, nozzles for spraying the solution, and slit type spraying openings of the nozzles. U.S. Pat. No. 5,197,673 discloses a nozzle assembly in which nozzles are coupled to nozzle bars.

The above-mentioned various circuit line widths and tolerance zones are determined depending on condition of liquid sprayed from nozzles equipped in these PCB wet line equipments. Treating capacity of the equipment depends on whether the same pressure and amount of chemical solution can be continuously sprayed throughout surfaces of PCBs or not.

Various kinds of nozzles are presently used as these spray nozzles, and type of a nozzle is determined depending on applications and characteristics of respective processes. Representative nozzles are classified into full-corn type and flat type nozzles.

The full-corn type nozzles are predominantly used in a process requiring high development and etching capability. The full-corn type nozzles spray liquid into a conical shape, and the liquid applied to an objective PCB has a circular shape in cross-section. In addition, the sprayed liquid is uniformly applied to a broad surface of an objective article under uniform pressure. The nozzles are fixedly disposed to be perpendicular to surface of a PCB such that uniform pressure is always applied to the whole surface of the PCB, thereby achieving certain development capability and excellent resolution. That is, chemical reaction is persistently caused by spraying chemical solution on a broad surface of a PCB under uniform pressure.

On the other hand, the flat type nozzles are predominantly used in a process requiring strong washing capability. The flat type nozzles spray liquid into a fan shape, and the liquid applied to an objective PCB has a linear shape in cross-section. Since strongly pressurized liquid is concentrated on a local area of a PCB into the linear shape, strong washing force is applied to the area of the PCB, and it is easy to remove foreign substance between circuits and in holes. Therefore, the flat type nozzles afford improvement in washing capability such as water washing process and acid pickling process. Although the nozzles are usually positioned to be perpendicular to a surface of a PCB, the nozzles may be positioned to be inclined with respect to the a surface of a PCB at a certain tilt angle to improve its washing capability, if required.

Spray nozzles are selectively used in respective processes or used in respective processes in combination depending on their uses.

It is the most important point to maintain constant spray pressure no matter what any type of nozzle is used. When the spray pressure is not constantly maintained, it is difficult to obtain desired quality. A typical wet line equipment is generally provided with a plurality of nozzles, which are disposed above and under PCBs and positioned with a certain spacing therebetween. In the wet line equipment, the lower nozzles allow constant pressure of liquid to be easily maintained because interference between liquids sprayed from nozzles is not intensive while the upper nozzles cause pressure resistance of liquid sprayed from the nozzles to be raised because the sprayed liquid flows along the nozzles and falls down.

Speaking more specifically, liquid sprayed from the lower nozzles or liquid spattered from PCBs flows along upper nozzle bars and then the upper nozzles. At this point, liquid sprayed from the upper nozzles interferes with liquid fallen from the upper nozzles. The interference between liquids is caused by a phenomenon in which liquid fallen from nozzles initially encounters liquid sprayed from nozzles and a phenomenon in which liquid sprayed from nozzles or spattered from PCBs flows along an outer surfaces of nozzles, falls down and encounters certain portion of liquid sprayed from nozzles.

In general, both types of interference concurrently occur in many places for one nozzle. Where an equipment having quite a few nozzles therein runs continuously for a long time, the interference occurs in all nozzles. Such interference is recognized at all places in a PCB wet line equipment employing nozzles.

Since the liquid interference hinders uniform spray pressure from being continuously applied to surfaces of products, produced PCBs suffer adverse effects on quality thereof. In high density products being recently developed, it is an essential requirement to achieve a constant circuit line width and uniform etching ability by the same chemical reaction occurring throughout surfaces of PCBs. Accordingly, it is an important solution to minimize interference between liquid sprayed from nozzles and liquid fallen from the nozzles.

FIG. 1 shows a general configuration of a conventional PCB wet line equipment. As shown in the drawing, the PCB wet line equipment includes a tank 1 containing treating liquid, a pump 2 for pumping the liquid from the tank 1, a conveyer for horizontally transferring PCBs 7, and a plurality of nozzles 5 disposed at upper and lower levels for spraying the treating liquid on upper and lower surfaces of the PCBs.

The PCBs 7 are clamped between a plurality of upper rollers and wheels and a plurality of lower rollers and wheels, and horizontally transferred by drive of the conveyer. During transfer of the PCBs 7, the treating liquid such as development solution and etching solution is diffusely sprayed from the plurality of upper and lower spray nozzles 5, which are arranged at upper and lower levels to face each other, and applied to the PCBs 7.

The treating liquid is pumped from the tank 1 and finally sprayed from the nozzles 5 through piping 3 and nozzle bars 4. The nozzles 5 are attached to the nozzle bars 4 at a certain interval. The PCBs 7 is placed on the conveyer driven by a motor, and thus moved through an inside of the equipment. The moving PCBs 7 are applied with treating liquid such as chemical solution sprayed from the upper and lower nozzles.

When the chemical liquid is sprayed from the upper and lower nozzles, the liquid sprayed from the lower nozzles flows along upper piping and the upper nozzles, and then falls down from the upper nozzles. The liquid fallen from the upper nozzles interferes with liquid normally sprayed from the upper nozzles. Accordingly, spraying areas of liquid sprayed from the upper nozzles are distorted, and liquid is apt to be unevenly sprayed, thereby causing surface treating ability, i.e., development quality to be deteriorated. Hence, this may have adverse effects on accuracy of circuits and thus quality of finished PCBs.

FIG. 2 shows interference phenomenon in liquid sprayed from conventional upper and lower nozzles 5, which are horizontally arranged at upper and lower levels. As shown in the drawing, interference phenomenon occurs between liquids during spaying of liquid. Specifically, liquid 20 sprayed from upper nozzles interferes with liquid fallen from the upper nozzles, thereby breaking uniform spray pressure of the liquid.

Therefore, an apparatus for preventing such interference between liquids has been proposed.

As described above, conventional nozzles used with a PCB wet line equipment are simply attached to nozzle bars to spray chemical solution or usual washing water.

Problems occurring when conventional nozzles are used will now be specifically described.

FIGS. 3 and 4 show spray shapes and interference phenomenon of liquid sprayed from conventional nozzles. As shown in FIG. 3, when chemical solution sprayed from lower nozzles and then scattered flows along upper nozzle bars 4 and upper nozzles 5 and falls down from the upper nozzles, the chemical solution fallen from the upper nozzles 5 interferes with liquid sprayed from the upper nozzles 5 and thus destroy normal shape of sprayed liquid, thereby hindering liquid with a certain pressure from being uniformly applied throughout surfaces of PCBs.

In addition, as shown in FIG. 4, when liquid flowing along the upper nozzle bars forms liquid drops on orifices of the nozzles, liquid cannot be sprayed into a desired shape from the nozzles 5, and spray shape of liquid is initially destroyed.

Though such abnormal spray of liquid must be avoid during treating process of PCBs, PCBs products have been persistently produced without separate solution for the problems up to this day. Hence, defective products are persistently generated, and it is difficult to fulfil mass production of high-density products.

### SUMMARY OF THE INVENTION

Accordingly, the present invention has been made keeping in mind the above problems occurring in the prior art, and the present invention suggests a nozzle for spraying PCBs which is intended to eliminate or minimize liquid interference occurring during liquid spraying, to be applied to an existing equipment without modification of the equipment and to be easily managed after installation.

It is an object of the present invention to provide a spray nozzle which is adapted to continuously spray liquid while maintaining constant spray pressure by preventing liquid interference occurring during spraying of liquid from the nozzle equipped in a PCB wet line equipment.

It is another object of the present invention to provide a spray nozzle which is adapted to maintain uniform spray pressure during spraying process to improve quality and performance of produced PCBs.

It is still another object of the present invention to provide a spray nozzle which is adapted to be applied to an existing equipment regardless of shape of the nozzle.

In order to accomplish the above object, the present invention provides a nozzle for spraying printed circuit board with pressurized liquid, the nozzle including a funnel-shaped cover attached to an upper portion of the nozzle and broadened toward an lower opening to hide the nozzle.

The present invention also provides a wet line equipment for printed circuit board including a conveyer moving horizontally on which printed circuit boards are placed, nozzle bars arranged at an upper level and/or a lower level at a certain interval, and a plurality of nozzles attached to the nozzle bars for spraying chemical treating liquid or washing liquid on the printed circuit boards, in which the plurality of nozzles are provided thereabove with funnel-shaped covers, respectively, to hide the nozzles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional PCB wet line equipment;

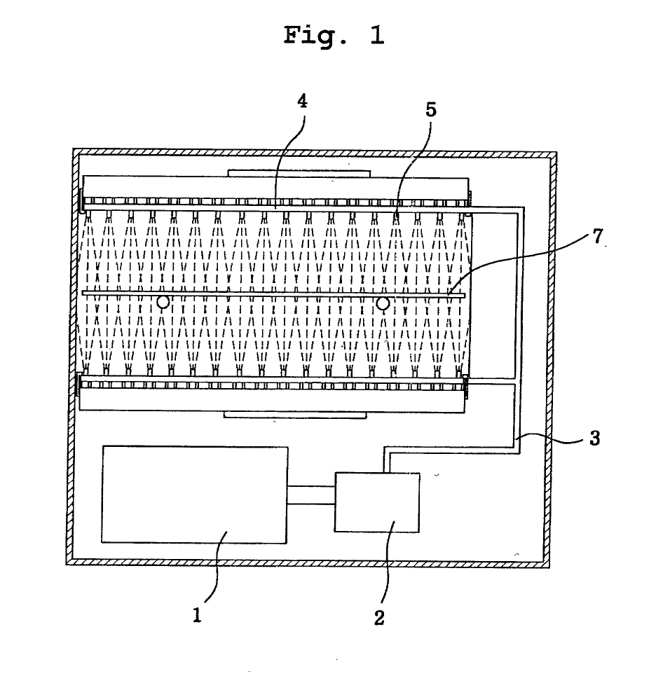

FIG. 2 is a view schematically showing interference phenomenon of liquid sprayed from conventional spray nozzles arranged at upper and lower levels;

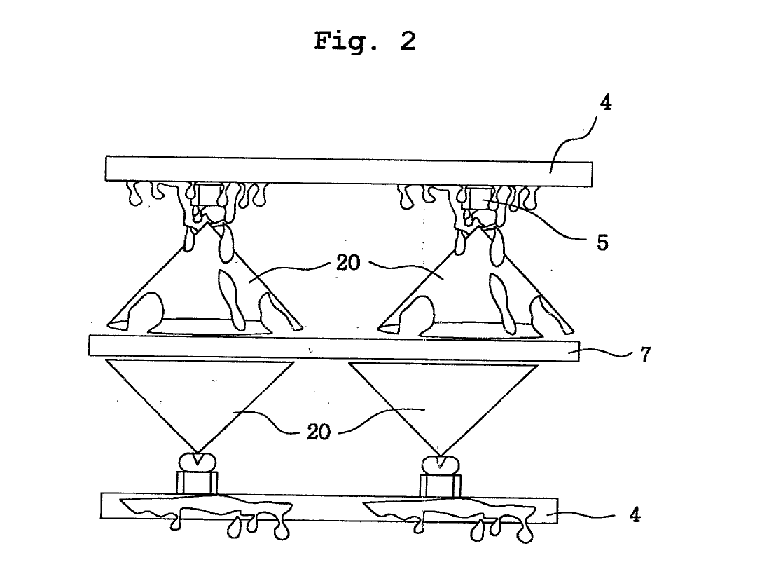

FIG. 3 is a-view showing interference phenomenon occurring at a conventional nozzle;

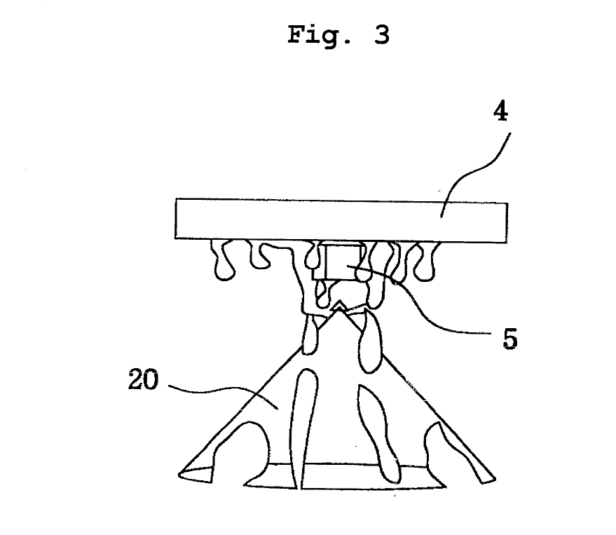

FIG. 4 is a view showing liquid sprayed from a conventional nozzle, which interferes with another liquid drop;

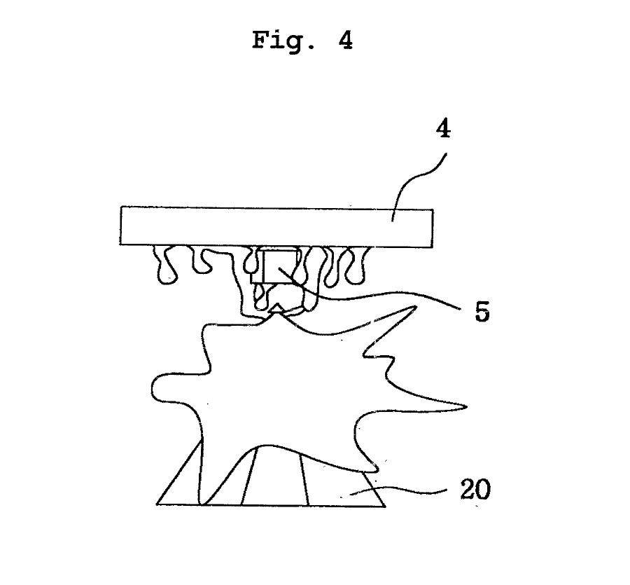

FIG. 5 is a view showing a nozzle with a cover according to the present invention for preventing interference phenomenon of liquid;

FIG. 6 is a cross-sectional view a spray nozzle with a cover according to the present invention; and

FIG. 7 is a view showing a nozzle which may be changed its cover sizes in accordance with spraying areas of a nozzle.

### DETAILED DESCRIPTION OF THE INVENTION

This invention will be described in further detail by way of example with reference to the accompanying drawings.

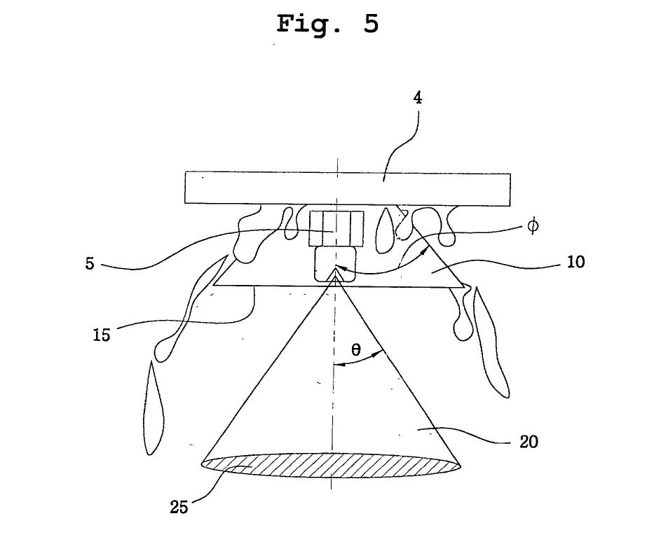

FIG. 5 shows an improved nozzle according to the present invention which is intended to solve problems occurring in a prior art.

As shown in FIG. 5, the nozzle according to the present invention is designed to prevent liquid interference by modifying its structure but components necessary to pump liquid from a tank and feed the liquid to nozzles through piping and nozzle bars are the same as or similar to prior art components. The key point of the improved nozzle according to the present invention is to prevent sprayed or scattered liquid from flowing down along the nozzle. To this end, the nozzle is provided thereabove with a funnel type nozzle cover 10. As a result, liquid flowed along the nozzle bar 4 flows down along the funnel type nozzle cover 10, so that the nozzle cover 10 can prevent liquid flowed along the nozzle bar 4 from encroaching on a spray range of liquid 20 sprayed from the nozzle.

The nozzle cover is attached to a upper portion of the nozzle and is shaped to have a funnel form, which is broadened toward a lower opening 15.

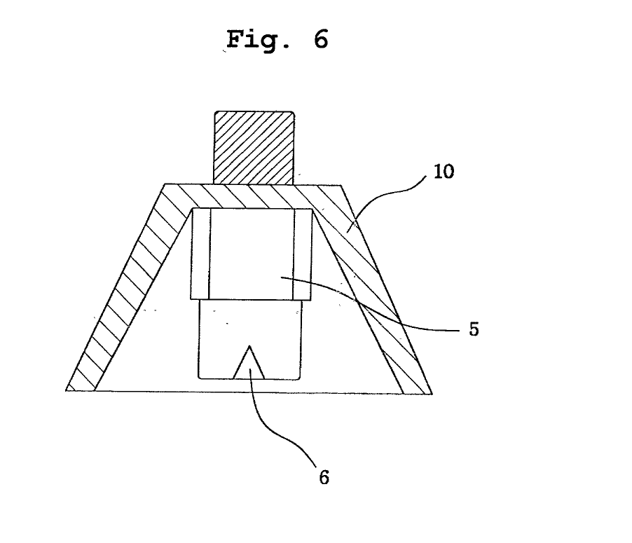

FIG. 6 is a cross-sectional view showing the nozzle equipped with the nozzle cover 10 according to an embodiment of the present invention. As shown in FIG. 6, in the nozzle with the nozzle cover, the cover 10 is attached to an upper portion of the nozzle 5, and comprises an upper surface and skirt-shaped side surface. The upper surface of the nozzle cover 10 is formed with a hole such that the nozzle cover 10 is coupled to the upper portion of the nozzle 5. The side surface of the nozzle cover is broadened toward the lower opening 15, so that the nozzle cover has a funnel shape. Although it is preferable that a vertical length of the side surface of the nozzle cover is the same as a length of the nozzle, the vertical length of the side surface may be longer or shorter than that of the nozzle. Although an inclined angle of the side surface of the nozzle Φ is the same as spray angle of liquid θ, the inclined angle Φ is not limited to this angle and may be changed if required.

A size of the nozzle cover may be diversely adjusted depending on a surface area of a PCB to which sprayed liquid is applied and a distance between the nozzle and a PCB. For example, when a base radius of a conical shape defined by sprayed liquid is large, the nozzle cover can have a large opening according to the base radius of, the conical shape. To prevent from occurring liquid interference during liquid spraying, it is desired to use nozzle cover 10 having the area of an opening 15 larger than spray area of a PCB 25.

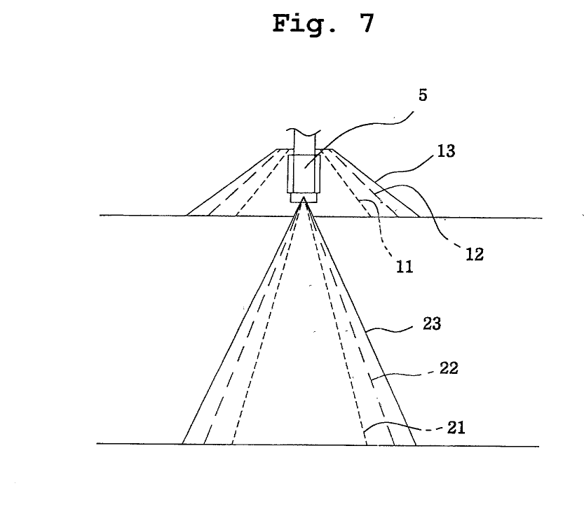

FIG. 7 shows an example of a nozzle cover 10, the size of which is controlled according to a spray angle of liquids or a spray area of a PCB 25. That is, the size of the nozzle cover becomes large by increment of the spray angle θ or spray area of a PCB 25. If the form of the spray is changed such as 21, 22 and 23, the nozzle cover 11, 12 and 13 is used to according to the forms of the spray 21, 22 and 23, respectively.

According to the present invention, with the nozzle cover attached to an upper portion of the nozzle, it is possible to prevent a normal shape of sprayed liquid from being disturbed and to prevent liquid flowed along a nozzle bar and a nozzle from falling in a spray range of liquid sprayed from a nozzle, and also it is possible to direct liquid fallen from a nozzle bar to an outside of the spray range.

Furthermore, since the nozzle cover can be made from material resistant to chemicals and environment in accordance with type of liquid, the nozzle with the nozzle cover according to the present invention can be applied to various chemicals. For example, the nozzle cover may be made of Tefron resin.

The nozzle cover can be simply applied to any equipment regardless of nozzle type and equipment configuration as long as the equipment has a structure to which the nozzle cover can be attached.

As described above, a nozzle with a cover according to the present invention has advantages in that it is possible to prevent interference between liquid fallen from a nozzle bar and liquid sprayed from the nozzle by minimization of amount of liquid flowing along a nozzle bar and the nozzle, and it is thus to maintain uniform spray pressure during spraying process for PCBs, thereby maintaining chemical reaction such as development and etching and washing capability uniformly.

The nozzle according to the present invention also allows defective fraction of products to be lowered to contribute to quality stabilization of PCBs, and can be applied to high-density products.

Furthermore, a nozzle with cover according to the present invention can be simply applied to any existing equipment without modification of the existing equipment; and can be simply and rapidly applied to any nozzle regardless of nozzle type.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A nozzle for spraying printed circuit board with pressurized liquid, the nozzle including a funnel-shaped cover attached to an upper portion of the nozzle and broadened toward a lower opening to hide the nozzle.

2. The nozzle as set forth in claim 1, said cover is made of Tefron resin.

3. The nozzle as set forth in claim 1, said cover has a lower opening, which is larger than a surface area of a PCB to which the liquid sprayed from the nozzle is applied.

4. The nozzle as set forth in claim 1, a vertical angle of said cover is the same as or larger than a spray angle of liquid sprayed from the nozzle.

5. A wet line equipment for printed circuit board including a conveyer moving horizontally on which printed circuit boards are placed, nozzle bars arranged at an upper level and/or a lower level at a certain interval, and a plurality of nozzles attached to the nozzle bars for spraying chemical treating liquid or washing liquid on the printed circuit boards, in which the plurality of nozzles are provided thereabove with funnel-shaped covers, respectively, to hide the nozzles.

6. The wet line equipment as set forth in claim 5, said cover is made of Tefron resin.

7. The wet line equipment as set forth in claim 5, said cover has a lower opening, which is larger than a surface area of a PCB to which the liquid sprayed from the nozzle is applied.

8. The wet line equipment as set forth in claim 5, a vertical angle of said cover is the same as or larger than a spray angle of liquid sprayed from the nozzle.

9. The wet line equipment as set forth in claim 5, the only upper nozzles of the plurality of nozzles are provided thereabove with funnel-shaped covers, respectively, to hide the nozzle.
